(19) United States
(12) Patent Application Publication
(10) Pub. No.: US 2002/0180750 A1
(43) Pub. Date: Dec. 5, 2002

(54) Display system

(75) Inventor: William A. Rozzi, Stillwater, MN (US)

Correspondence Address: Imation Corp., PO Box 64898, St. Paul, MN, 55164-0898, US

(73) Assignee: Imation Corp.

(21) Appl. No.: 09/867,053

(22) Filed: May 29, 2001

(51) Int. Cl. G09G 5/02

(52) U.S. Cl. 345/589

(57) ABSTRACT

In one embodiment the invention comprises a display device including at least one illuminant condition sensor. The illuminant condition sensor can provide feedback to the display device regarding the illuminant conditions surrounding the display. Alternatively, the output of the illuminant condition sensor can provide input to a color management module. Either way, illuminant condition information can be provided so that the display device renders color in a manner that accounts for illuminant conditions.

### The invention relates to color imaging and, more particularly, to display systems for soft proofing of color imagery.

### BACKGROUND

Display devices include devices having displays such as cathode ray tubes (CRTs), liquid crystal displays (LCDs) or other flat screen displays, digital paper, plasma displays, electronic ink displays, and other devices capable of producing a visible representation of an image. Typically, display devices make use of device-dependent coordinates to define color. For instance, a display device having a CRT display may use red, green, and blue (RGB) coordinates to define color. The display device may use different combinations of red, green, and blue phosphors to display colors within the RGB gamut of the CRT display.

Many different device-independent coordinate systems have been developed in an attempt to standardize color specification across different imaging devices. For instance, the Commission Internationale de l'Eclairage (CIE) has developed device-independent color spaces such as the L*a*b* color space (hereafter L*a*b* color space, L*a*b* space, or simply L*a*b*) and the XYZ color space (hereafter XYZ color space, XYZ space, or simply XYZ). Moreover, several other organizations and individuals have developed other device-independent colors spaces.

Accurate color rendering on a display device is highly desirable. For obvious reasons, it is generally desirable to render visually pleasing images to an end user. However, for some applications, such as “soft-proofing” and other color imaging applications, very accurate color rendering is imperative.

The term “soft proofing” refers to a proofing process that makes use of a display device rather than a printed hard copy. Traditionally, color proofing techniques have relied on “hard copy proofing,” where proofs are printed out and inspected to ensure that the images and colors on the print media look visually correct. For instance, color characteristics can be adjusted and successive hard copy prints can be examined in a hard proofing process. After determining that a particular proof is acceptable, the color characteristics used to make the acceptable proof can be reused to mass-produce, e.g., on a printing press or high-volume printer, large quantities of print media that look visually equivalent to the acceptable proof.

Soft proofing is desirable for many reasons. For instance, soft proofing can eliminate the need to print hard copies on media during the proofing process. Moreover, soft proofing may allow multiple proofing specialists to proof color images from remote locations simply by looking at display devices. SQft proofing can be faster and more convenient than hard proofing. Moreover, soft proofing can reduce the cost of the proofing process. For these and other reasons, soft proofing is highly desirable.

Realizing soft proofing, however, has proven to be very difficult. For instance, the inability to achieve adequate color matches between hard copies and display devices has generally limited the effectiveness of soft proofing. Color management tools and techniques have been developed to improve the accuracy of color matching between the outputs of different devices. For instance, color profiles used to categorize and define imaging devices, and color matching software such as color matching modules (CMMs) have been developed for this purpose. Still, a number of variables continue to compromise the goal of effective color matching in soft proofing environments and other color imaging environments.

In this document the term image refers broadly to any type of graphical rendering. For example, an image could simply be a page of text, a picture, a chart, or another pictorial device such as user interface elements like buttons or windows generated by a computer's operating system software. Generally, a graphical element or any collection of graphical elements can comprise an image.

### SUMMARY

The invention may comprise methods for automatically adjusting display characteristics of a display device according to illuminant conditions surrounding the display device, display devices including at least one illuminant condition sensor, and systems including at least one display device that has an illuminant condition sensor. In one embodiment, for example, a display device may include a display that produces a visible representation of an image. The display device may also include an illuminant condition sensor that senses illuminant conditions surrounding the display device. In addition, the display device may include computer circuitry that calibrates the display according to the illuminant conditions sensed by the sensor. Alternatively, the output of the illuminant condition sensor may provide input to a color matching module.

The display device may include a display such as a CRT, an LCD or other flat screen display, digital paper, a plasma display, an electronic ink display, or any other device capable of producing a visible representation of an image. The illuminant condition sensor may form part of the display device. By way of example, the illuminant condition sensor may comprise a charge coupled device (CCD) such as a linear charged coupled device or a two-dimensional array charged coupled device. Alternatively, the illuminant condition sensor may comprise a charge injection device, a photomultiplier tube, a photodiode, a complimentary metal oxide semiconductor (CMOS), one or more spectral sensors, or any other photosensitive device capable of measuring illuminant conditions in the environment surrounding the display device.

The illuminant condition sensor may sense display emission characteristics of the display device in addition to illuminant conditions surrounding the display device. Alternatively, the display device may include a second sensor that senses display emission characteristics.

The display device may further include computer circuitry coupled to the illuminant condition sensor or the illuminant condition sensor and the second sensor. For instance, the computer circuitry may automatically calibrate the display according to sensed illuminant conditions and sensed display emission characteristics. Alternatively, the sensed conditions and characteristics can provide input to a color matching module. In one embodiment, a single sensor can be positioned at a first location to detect illuminant conditions and positioned at a second location to detect emission characteristics.

In another embodiment a method includes sensing illuminant conditions with an illuminant condition sensor that forms part of a display device, and automatically adjusting display characteristics of the display device according to the sensed illuminant conditions. The illuminant condition sensor may provide input to a display driver, and the display characteristics of the display device may be automatically adjusted by the display driver. Alternatively, the illuminant condition sensor may provide input to calibration circuitry, and the display characteristics of the display device may be automatically adjusted by the calibration circuitry.

The method may further include sensing display emission characteristics and automatically adjusting display characteristics of the display device according the display emission characteristics. For instance, the display emission characteristics may be sensed by the illuminant condition sensor, or alternatively by a second sensor. For non-emissive display devices such as digital paper and electronic ink displays, sensing display characteristics may include illuminating the display device and sensing the reflection characteristics. In that case, the sensor may include a light source or the like for illuminating the display device.

In yet another embodiment, a method includes sensing illuminant conditions with an illuminant condition sensor that forms part of a display device, and adjusting color data according to the sensed illuminant conditions. Again, the illuminant condition sensor may include a charged coupled device, a charge injection device, a photomultiplier tube, a photodiode, a complimentary metal oxide semiconductor, spectral sensors, or any other photosensitive device capable of measuring illuminant conditions in the environment surrounding the display device.

Adjustment of the color data may occur in a color matching module. For example, the adjustment may occur according to an illuminant condition algorithm or an illuminant condition look-up table. The method may further include sensing display emission characteristics and adjusting color data according the sensed display emission characteristics. The display emission characteristics may be sensed by the illuminant condition sensor, or alternatively by a second sensor. For instance, adjusting color data according the sensed display emission characteristics may comprise altering the color data, e.g., in a color matching module. The color matching module may include an emission characteristics algorithm or an emission characteristics look-up table for this purpose.

In still another embodiment a system may include a display device including an illuminant condition sensor that senses illuminant conditions surrounding the display device. The system may also include a color matching module coupled to the sensor that adjusts color data according to the sensed illuminant conditions. Again, the illuminant condition sensor may be a charged coupled device, a charge injection device, a photomultiplier tube, a photodiode, a complimentary metal oxide semiconductor, one or more spectral sensors, or any other photosensitive device capable of measuring illuminant conditions in the environment surrounding the display device.

The color matching module may adjust color data according the sensed illuminant conditions by altering the color data. For instance, the color matching module may alter the color data according to an illuminant condition algorithm or an illuminant condition look-up table.

The illuminant condition sensor may further sense emission characteristics of the display device. Alternatively, the system may include a second sensor for sensing emission characteristics of the display device. The color matching module may adjust color data according the sensed emission characteristics, for instance, by altering the color data. The color matching module may perform the alteration of color data according to an emission characteristics algorithm or an emission characteristics look-up table.

The system may further include color management control coupled to the display device. Moreover, the color matching module may reside in the color management control. In addition, the system may include at least one printing device such as a printing press or a high volume printer. The printing device may be coupled to the color management control. The system may also include a plurality of a display devices, each coupled to the color management control, and each including an illuminant condition sensor that senses illuminant conditions surrounding the respective display device.

Additional details of these and other embodiments are set forth in the accompanying drawings and the description below. Other features, objects and advantages will become apparent from the description and drawings, and from the claims.

### BRIEF DESCRIPTION OF THE DRAWINGS

FIG. 1 is a block diagram according to one embodiment of the invention.

FIG. 2 is a block diagram illustrating a system suitable for implementation of imaging techniques according to embodiments of the invention.

FIG. 3 illustrates a color management system according to an embodiment of the invention.

FIGS. 4 and 5 are block diagrams according to embodiments of the invention that do not make use of a CMM.

FIGS. 6-9 are flow diagrams according to embodiments of the invention.

FIG. 10 illustrates an exemplary soft proofing system.

### DETAILED DESCRIPTION

In exemplary embodiments, the invention comprises methods for automatically adjusting display characteristics of a display device according to illuminant conditions surrounding the display device, display devices including at least one illuminant condition sensor, and systems including at least one display device that has an illuminant condition sensor. In one example, for instance, a display device includes an illuminant condition sensor that provides feedback to the display device regarding the illuminant conditions surrounding the display device. The display device may automatically adjust its display characteristics according to the illuminant conditions detected by the illuminant condition sensor. Alternatively, the output of the illuminant condition sensor can provide input to a color matching module (CMM).

As mentioned above, accurate color rendering on a display device and accurate color matching between the output of a display device and other imaging devices is highly desirable. One factor that affects accurate color rendering and accurate color matching, for instance, is display device calibration. If a display device is not properly calibrated, then color rendering may not be accurate. Unfortunately, display characteristics can become skewed over time. For instance, the emission characteristics of each of the red, green, and blue phosphors of a CRT display can change over the lifetime of a given display. Moreover, the illuminant conditions surrounding a particular display device can change at any time with the flick of a light switch.

Display calibration and recalibration can be performed by measuring light emission characteristics of the display device. For instance, this can be done using an external light measuring apparatus such as a spectroradiometer to measure emission characteristics of each of the red, green, and blue phosphors of the display in the display device. The measured emission characteristics can be compared to a target white point having a defined set of chromaticity values. The CRT settings can then be adjusted to match the known chromaticity values for the targeted white point. This adjustment may be manual or automatic.

Similarly, an external light measuring apparatus can be used to measure illuminant conditions. If the illuminant conditions change, the CRT settings may be adjusted to account for the change in viewing conditions.

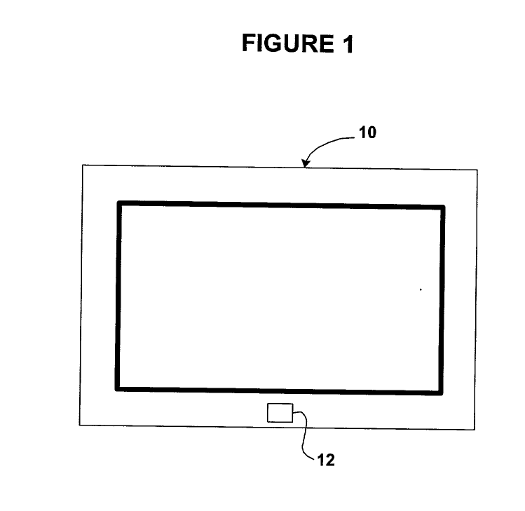

FIG. 1 is a block diagram according to one embodiment of the invention. A display device 10 may include an illuminant condition sensor 12 for sensing illuminant conditions surrounding the display device 10. Display device 10 may include any type of display such as a CRT, an LCD or other flat screen display, digital paper, a plasma display, an electronic ink display, or any other device capable of rendering a visible representation of an image. Display device 10 may be coupled to or form part of a conventional computer system. By measuring illuminant conditions, illuminant condition sensor 12 provides important input for controlling the characteristics of the image displayed by display device 10, and thereby facilitates more accurate color matching that is necessary for effective soft proofing.

Illuminant condition sensor 12 may include at least one photosensitive element capable of measuring illuminant conditions in the environment surrounding display device 10. For instance, illuminant condition sensor 12 may be capable of measuring light intensity, or the frequency or wavelength of light. Illuminant condition sensor 12 may be coupled to computer circuitry that automatically adjusts the display characteristics of display device 10 according to illuminant conditions sensed by the illuminant condition sensor 12. The circuitry, for instance, may be internal to the display device 10 or may reside outside of the display device 10. In one embodiment, the computer circuitry automatically adjusts display characteristics of display device 10 according to illuminant conditions sensed by illuminant condition sensor 12. In that case, the computer circuitry may reside in a central processing unit coupled to the display device 10. The computer circuitry may control a video driver to compensate for different illuminant conditions.

In a different embodiment described in greater detail below, the illuminant condition sensor 12 provides input to a CMM. The CMM may implement an algorithm or look-up table, for instance, to match the color output of the display device 10 to that of a source device. Using color profiles of the display device 10 and the source device, along with the illuminant conditions calculated by the illuminant condition sensor 12, the CMM may alter the colorimetric characteristics of color data that is sent to the display device so that the output of the display device will be a more accurate visual match to that of the source device. Thus, in contrast to the control of a video driver, the CMM adjusts the color values of graphical elements or other images according to the illuminant conditions detected by sensor 12.

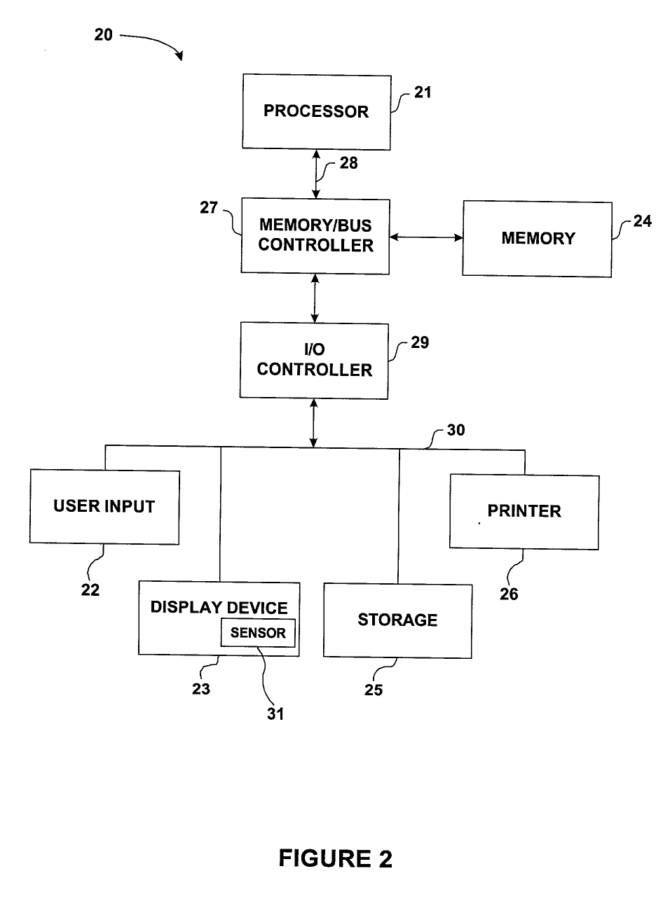

FIG. 2 is a block diagram illustrating a system 20 suitable for implementation of imaging techniques according to embodiments of the invention. As shown in FIG. 2, system 20 may include processor 21, user input device 22, display device 23, memory 24, storage device 25, and printer 26. Display device 23, for example, may be a display device having an integrated illuminant condition sensor 31 for sensing illuminant conditions surrounding the display device 23.

System 20 may substantially conform to conventional systems used by graphic artists and other users in the creation of graphic imagery for electronic display or print production. A memory/bus controller 27 and system bus 28 couple processor 21 and memory 24, while one or more I/O controllers 29 and I/O bus 30 couple the processor and memory to user input device 22, display device 23, storage device 25, and printer 26.

Processor 21 may take the form of a general purpose microprocessor and can be integrated with or form part of a PC, Macintosh, computer workstation, hand-held data terminal, palm computer, digital paper, or the like. User input device 22 may include a conventional keyboard and pointing device such as a mouse, pen, or trackball, if desired. As mentioned, display device 23 may be any display device that displays images such as textual and/or graphic information to the user. Moreover, display device 23 may include an illuminant condition sensor 31. Memory 24 may include random access memory (RAM) storing program code that is accessed and executed by processor 21 to carry out methods of color imaging or display characteristic adjustment.

The program code can be loaded into memory 24 from storage device 25, which may take the form of a fixed hard drive or removable media drive associated with system 20. For example, the program code can be initially carried on computer-readable media such as magnetic, optical, magneto-optic or other disk or tape media.

Alternatively, the program code may be loaded into memory from electronic computer-readable media such as electrically-erasable-programmable-read-only-memory (EEPROM), or downloaded over a network connection. If downloaded, the program code may be initially embedded in a carrier wave or otherwise transmitted on an electromagnetic signal. The program code may be embodied as a feature in an application program providing a wide range of imaging functionality.

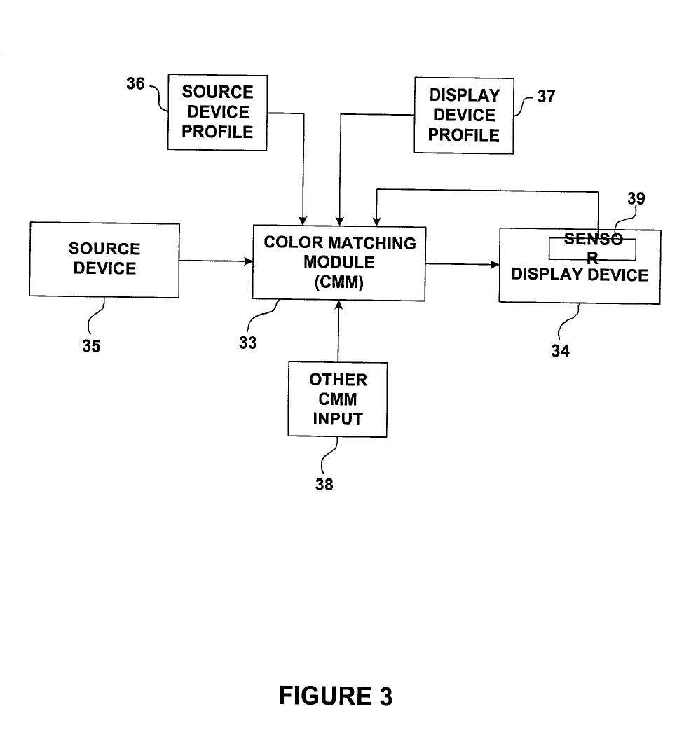

FIG. 3 illustrates a system of color management according to an embodiment of the invention. Color matching module 33, for example, may be a computer program that facilitates color matching between a display device 34 and a source device 35. The computer program may operate in a system like the one illustrated in FIG. 2 and described above.

Source device 35 may be an imaging device such as a display device, a printer or a scanner. Display device 34 may be any type of display such as a CRT, an LCD or other flat screen display, digital paper, a plasma display, an electronic ink display, or any other device capable of producing a visible representation of an image.

The source device profile 36 and the destination device profile 37 can provide CMM 33 with input that facilitates color matching between the source device 35 and display device 34. For example, the profiles 36, 37 may be used to provide transformations for transforming device-dependent coordinates to device-independent coordinates. The transformations, for example, can be in the form of one or more algorithms, mathematical relationships or look-up tables. In some implementations, the profiles 36, 37 may include both forward and reverse transformations between device-dependent coordinates and device-independent coordinates.

The forward transformation transforms device-dependent coordinates to device-independent coordinates, and the reverse transformation transforms device-independent coordinates to device-dependent coordinates. The device-independent coordinates, for example, may be in any of a variety of color spaces, such as spectral coordinates, XYZ coordinates, L*a*b* coordinates, L*u*v* coordinates, or custom color space coordinates. The device-dependent coordinates may be RGB coordinates, CMYK coordinates, or the like.

In addition to device profiles 36, 37, CMM 33 may receive other input information such as illuminant condition information. This illuminant condition information can be automatically provided to CMM 33 via an illuminant condition sensor 39 that forms part of display device 34. CMM 33 may then use the illuminant condition information along with the profiles 36, 37 to systematically alter the values of device-dependent coordinates that are sent to the display device 34 so that the output of the display device will be a more accurate visual match to that of the source device 35. CMM 33 may implement an algorithm or a look-up table for this purpose.

Integrating illuminant condition sensor 39 into a display device 34 can provide several advantages, such as automatically inputting illuminant condition information into CMM 33. If illuminant condition sensor 39 forms part of display device 34, it can always measure the illuminant conditions proximate to the output of the display device 34. In a soft proofing environment, for example, illuminant conditions could be different for different display devices. If each display device had its own integrated illuminant condition sensor 39, however, any variation in illuminant conditions would be identified. In other words, integrating an illuminant condition sensor 39 with a display device ensures that positional or temporal variations in illuminant conditions are always identified, e.g., positional variations between two different display devices in a soft proofing system, temporal variations throughout the course of a day, or variations produced by movement of a particular display device to different locations. The illuminant condition sensor may be positioned so as to optimize the ability to detect the illuminant conditions surrounding the display device. For example, in one embodiment, the illuminant condition sensor is positioned so that it only detects illuminant conditions and does not detect any light emitted from the display device itself. In other embodiments, however, it may be desirable to detect emission characteristics in addition to the illuminant conditions.

Automatically inputting illuminant condition information into CMM 33 may ensure that color matching is achieved even if illuminant conditions change. In other words, automatically inputting illuminant condition information into CMM 33 ensures that temporal variations in illuminant conditions at the same location are always identified. Rather than assuming a default set of illuminant conditions, closed loop tracking of illuminant conditions at the time and place of display offers significant color matching advantages.

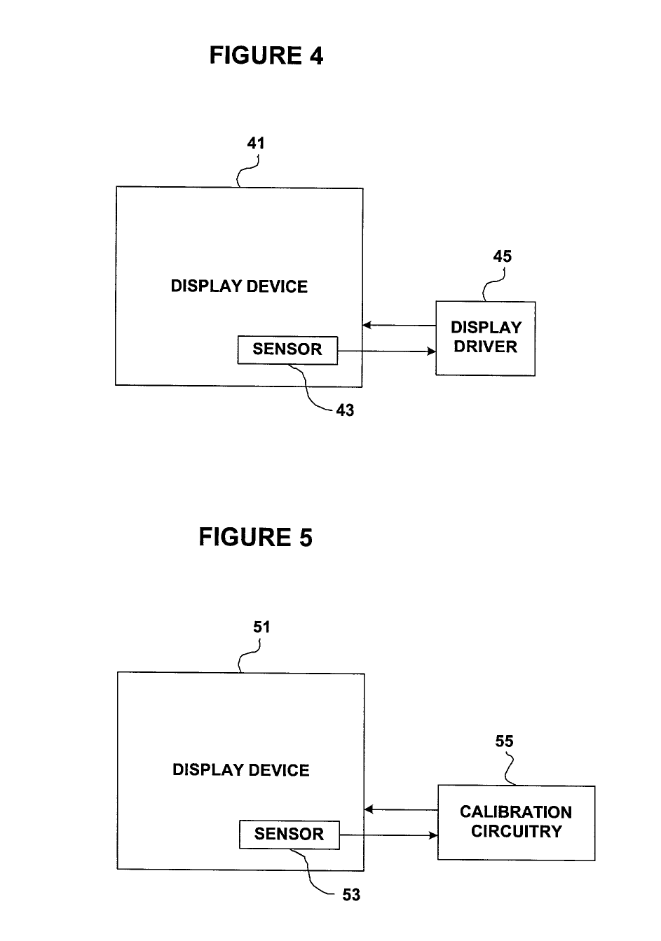

FIGS. 4 and 5 illustrate embodiments of the invention that do not make use of a CMM. Display device 41, 51 may automatically adjust respective display characteristics according to illuminant conditions surrounding the respective display device 41, 51.

The display device 41, 51 includes an illuminant condition sensor 43, 53 that provides feedback to the display device 41, 51 regarding the illuminant conditions surrounding the display device 41, 51. The display device 41, 51 can automatically adjust its display characteristics according to the illuminant conditions detected by the illuminant condition sensor 43, 53.

For example, as shown in FIG. 4, display device 41 may be driven by a display driver 45 that receives illuminant condition information. The display driver 45 may adjust input parameters sent to the display of the display device according to the illuminant condition information that it receives from illuminant condition sensor 43. In this manner, the output of the display device 41 may look the same to a user regardless of the illuminant conditions surrounding the display device 41. If illuminant conditions change, so will input parameters calculated by the device driver 43. Therefore, the output of the display device 41 will be visually consistent even if the illuminant conditions that illuminate the display device 41 change.

FIG. 5 illustrates how calibration circuitry 55 may be implemented to self-calibrate a display device 51. Calibration circuitry 55, for example, may automatically calibrate display characteristics of display device 51 according to illuminant conditions surrounding the display device. Illuminant condition sensor 53 can be integrated to form part of display device 51. Illuminant condition sensor 53 detects and measures the illuminant conditions and provides input pertaining to the illuminant conditions to calibration circuitry 55. Calibration circuitry 55 calibrates display device 51, accounting for the illuminant conditions. In this manner, the output of the display device 51 will be visually consistent even if the illuminant conditions that illuminate the display device 51 change.

Calibration circuitry 55 may reside inside display device 51. Alternatively, calibration circuitry 55 may reside outside display device 51, but within a computer system associated with display device 51. For example, in one embodiment, calibration circuitry 55 resides in a central processing unit (CPU) associated with display device 51.

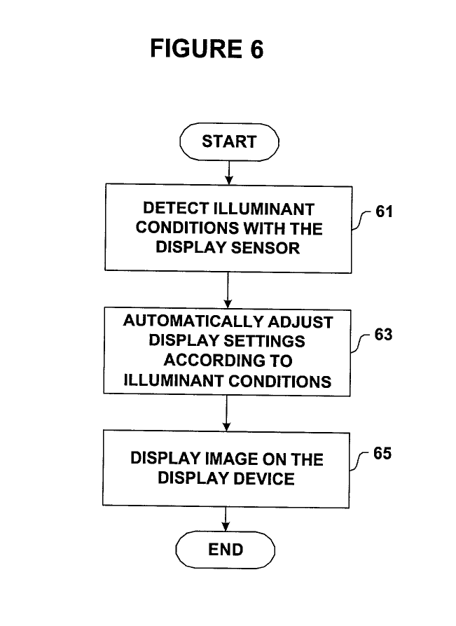

FIG. 6 is a flow diagram according to an embodiment of the invention. As shown, illuminant conditions can be detected with a display sensor (61) such as an illuminant condition sensor. Then, having detected the illuminant conditions (61) display settings can be automatically adjusted according to the illuminant conditions (63), before displaying an image on the display device (65). For instance, the operation of automatically adjusting display settings can be performed in software such as a display driver as shown in FIG. 4 or in hardware such as calibration circuitry as shown in FIG. 5.

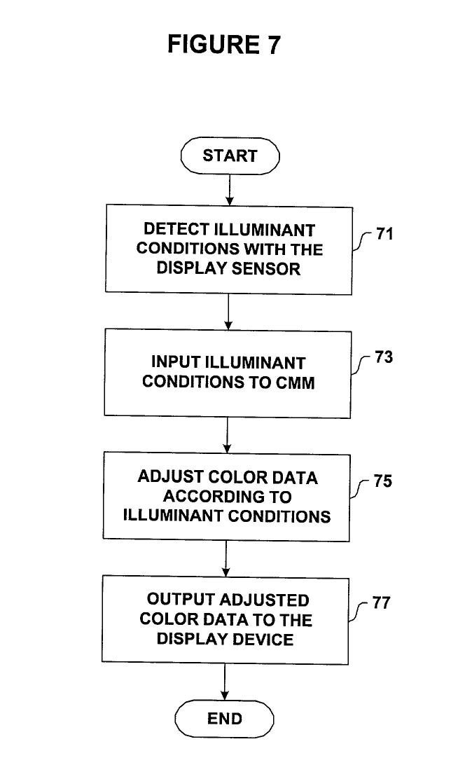

FIG. 7 is another flow diagram according to an embodiment of the invention. As shown, illuminant conditions can be detected with a display sensor (71) such as an illuminant condition sensor. The illuminant conditions may then be inputted to a CMM (73). Color data can be adjusted according to the illuminant conditions (75). In addition, the color data may be adjusted according to other input parameters. Having adjusted the color data, the color data can be outputted to the display device (77). In this manner, the output of the display device can be adjusted according to illuminant conditions surrounding the display device.

The illuminant condition sensor is a sensor that measures illuminant conditions. The illuminant condition sensor may include at least one photosensitive element. By way of example, the illuminant condition sensor may comprise a charge-coupled device (CCD), a charge injection device (CID), a photodiode, a photomultiplier tube, a spectroradiometer, one or more spectral sensors, a complimentary metal oxide semiconductor, or any other photosensitive device.

A linear CCD, for example, may provide a relatively low cost alternative for an illuminant condition sensor. A CCD generally employs a light sensitive material on a silicon chip to electronically detect photons. The chip also contains integrated circuitry to transfer a signal generated by the detected photons along a row of picture elements. When individual picture elements are arranged in a single row, the CCD is referred to as a linear array. When the pixels are arranged in rows and columns, the CCD is referred to as a two-dimensional array.

As detailed above, several advantages are realized by integrating the illuminant condition sensor in a display device. Additional features can also be added to the display device to enhance or improve the performance of the illuminant condition sensor. For instance, a sensor door can be added to protect the sensor from the environment, e.g., when it is not being used. In addition, the illuminant condition sensor can be made retractable. For instance, the display device can be adapted to expose the sensor to the environment when the sensor is in use, and to retract the sensor into the display housing when the sensor is not in use. In addition, the illuminant condition sensor may be positioned so as to optimize the ability to detect illuminant conditions. For example, the illuminant condition sensor may be positioned on the top of the display device, or proximate to the emissive output if the display device is an emissive device. In the latter case, it may be desirable to shield the emissive output of the display device from the illumination condition sensor. Alternatively, as described below, the illuminant condition sensor may be used to sense emission characteristics of the display device in addition to illuminant conditions surrounding the display device. These and other features can enhance the performance of an illuminant condition sensor.

In other embodiments, a display sensor can perform illuminant condition sensing functions along with other sensing functions. For example, the sensor may detect display emission characteristics. The sensed emission characteristics can then be used to automatically re-calibrate the display device in a manner that is similar to the way illuminant condition information is used to automatically adjust display characteristics. If the emission characteristics drift or otherwise change over time, the display device can automatically detect the drift and adjust emission parameters accordingly. If the display device is non-emissive, such as digital paper and electronic ink displays, the sensor may operate with an illuminator to sense the reflection characteristics of the display device. The illuminator may be a light source, or the like.

The sensing of emission characteristics or reflection characteristics of a particular display device can be used to measure the gamut of the display device. Then, the measured gamut could be used in a process of building a profile for the device. For example, the gamut of the display device, as measured by sensing emission characteristics or reflection characteristics, could be used to define the gamut of device. That defined gamut could then be incorporated within the device profile.

If the sensor is made to be retractable, it could further be positioned at a first location to detect illuminant conditions and positioned at a second location to detect emission or reflection characteristics. Alternatively, a separate sensor could be implemented for purposes of detecting the emission or reflection characteristics.

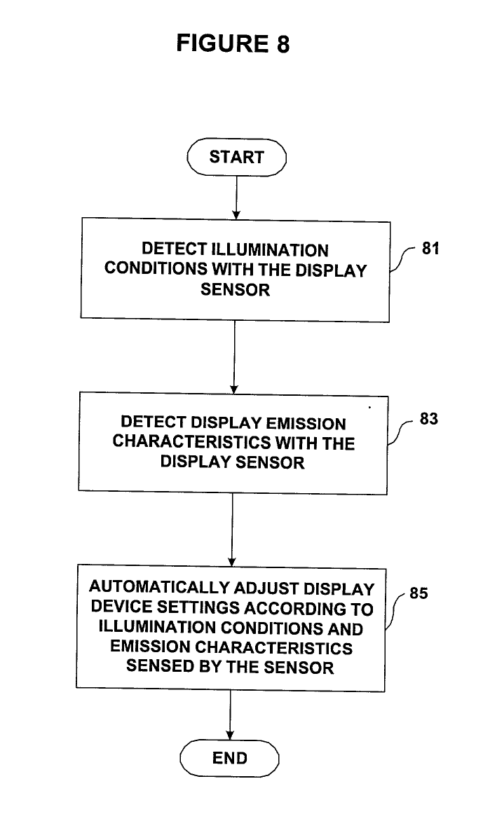

FIG. 8 is a flow diagram according to an embodiment according of the invention. As shown, illuminant conditions may be detected with a display sensor (81) such as an illuminant condition sensor. Moreover, emission characteristics of the display device may also be detected with the display sensor (83). Display device settings can then be automatically adjusted according to the illuminant conditions and the emission characteristics detected by the sensor (85). In this manner, the display device can automatically account for variations in illuminant conditions and variations in display emission characteristics. In other embodiments, implementing non-emissive display devices, the display reflection characteristics are detected. In that case, display settings are automatically adjusted according to the illuminant conditions and the reflection characteristics.

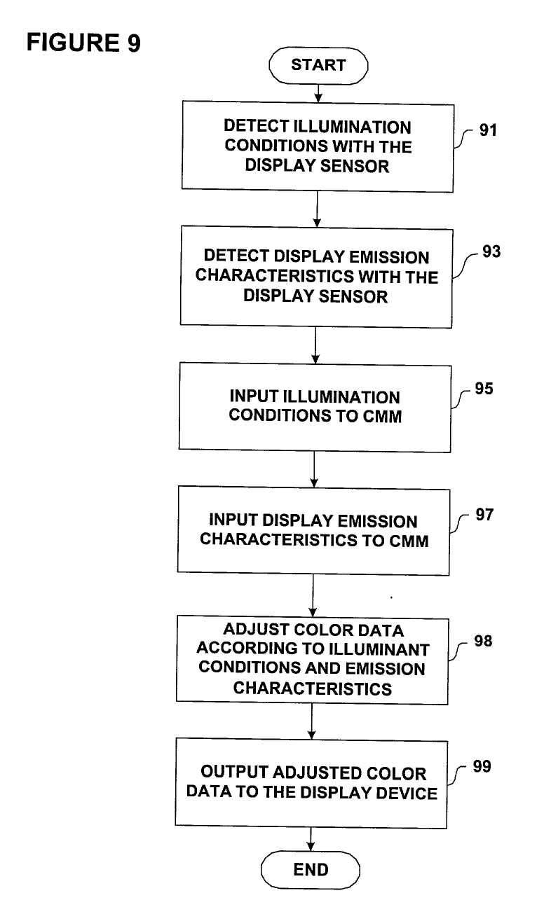

FIG. 9 is a flow diagram according to yet another embodiment according to the invention. As shown, illuminant conditions may be detected with a display sensor (91) such as an illuminant condition sensor. Moreover, emission characteristics of the display device may also be detected with the display sensor (93). Illuminant conditions and emission characteristics can then be inputted to a CMM (95 and 97). The CMM can then adjust color data according to illuminant conditions and emission characteristics (98). For example, the CMM may systematically alter the outputted device-dependent coordinates so that the output of the display device will be a more accurate visual match to that of a source device. In this manner, systematically altering the device-dependent coordinates can account for variations in illuminant conditions and emission characteristics sensed by the display sensor. After adjusting the color data, the color data may be sent to the display device (99). Again, a similar embodiment implementing non-emissive display devices involves detecting display reflection characteristics and inputting the reflection characteristics to the CMM.

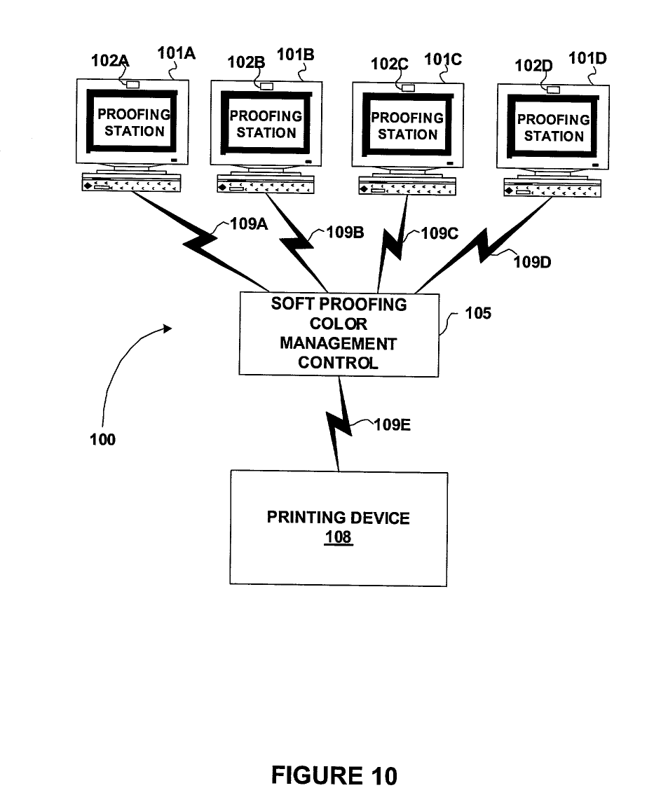

FIG. 10 illustrates an exemplary soft proofing system 100. Soft proofing system 100 may implement one or more aspects of the invention to realize accurate color generation and color matching in a proofing process. Soft proofing system 100 may include one or more proofing stations 101A-101D. The proofing stations 101A-101D may include display devices that have integrated illuminant condition sensors 102A-102D. These illuminant condition sensors 102A-102D may operate as described above.

Soft proofing system 100 may also include a soft proofing color management control 105. The soft proofing color management control 105 may include one or more CMMs, display drivers, or calibration circuitry. Moreover, the soft proofing color management control 105 may receive illuminant condition information from the illuminant condition sensors 102A-102D of the respective display devices associated with proofing stations 101A-101D. Soft proofing management control 105 may use information provided from the respective illuminant condition sensors to ensure that images rendered at the respective proofing stations 101A-101D look visually equivalent.

Soft proofing system 100 may also include at least one printing device 108, such as a printing press. In operation, soft proofing system 100 may generate a color image at the respective proofing stations 101A-101D. Color specialists may inspect the image at respective proofing stations 101A-101D and may adjust the visual appearance of the image. Once the image looks acceptable at the proofing stations 101A-101D, printing device 108 may be used to mass print large quantities print media that look visually equivalent to the image displayed at the proofing stations 101A-101D. Importantly, implementing the techniques and teachings outlined above can help ensure that the images that appear at the proofing stations 101A-101D will indeed look more visually equivalent to the images printed by printing device 108. Communication links 109A-109E that connect the proofing stations 101A-101D and printing device 108 to the soft proofing management control 105 may be wired or wireless.

A number of implementations and embodiments of the invention have been described. For instance, many variations of integrating an illuminant condition sensor within a display device have been described. Nevertheless, it will be understood that various modifications may be made without departing from the spirit and scope of the invention. Accordingly, other implementations and embodiments are within the scope of the following claims.

1. A display device including:
a display that produces a visible representation of an image; and
an illuminant condition sensor that senses illuminant conditions surrounding the display device.

2. The display device of claim 1, further comprising computer circuitry that calibrates the display according to the illuminant conditions sensed by the sensor.

3. The display device of claim 1, wherein the illuminant condition sensor senses display emission characteristics of the display in addition to illuminant conditions surrounding the display device.

4. The display device of claim 3, further comprising computer circuitry coupled to the sensor, the computer circuitry automatically calibrating the display according to illuminant conditions sensed by the sensor and display emission characteristics sensed by the sensor.

5. The display device of claim 1, further comprising a second sensor that senses display emission characteristics.

6. The display device of claim 1, wherein the illuminant condition sensor senses display emission characteristics of the display in addition to illuminant conditions surrounding the display device, and wherein the sensor can be positioned at a first location to detect illuminant conditions and positioned at a second location to detect emission characteristics.

7. The display device of claim 1, wherein the sensor comprises a charge coupled device.

8. The display device of claim 7, wherein the charged coupled device is a linear charged coupled device.

9. The display device of claim 1, wherein the sensor forms part of the display device.

10. The display device of claim 1, wherein the sensor comprises a charge injection device.

11. The display device of claim 1, wherein the sensor comprises a photomultiplier tube.

12. The display device of claim 1, wherein the sensor comprises a photodiode.

13. The display device of claim 1, wherein the sensor comprises a spectroradiometer.

14. The display device of claim 1, wherein the sensor comprises a complimentary metal oxide semiconductor.

15. A method comprising:
sensing illuminant conditions with an illuminant condition sensor that forms part of a display device; and
automatically adjusting display characteristics of the display device according to the sensed illuminant conditions.

16. The method of claim 15, wherein the illuminant condition sensor provides input to a display driver, and wherein the display characteristics of the display device are automatically adjusted by the display driver.

17. The method of claim 15, wherein the illuminant condition sensor provides input to calibration circuitry, and wherein the display characteristics of the display device are automatically adjusted by the calibration circuitry.

18. The method of claim 15 wherein sensing illuminant conditions with an illuminant condition sensor comprises sensing illuminant conditions with a charged coupled device.

19. The method of claim 15, further comprising sensing display emission characteristics and automatically adjusting display characteristics of the display device according the display emission characteristics.

20. The method of claim 19, wherein sensing display emission characteristics comprises sensing display emission characteristics with the illuminant condition sensor.

21. A method comprising:
sensing illuminant conditions with an illuminant condition sensor that forms part of a display device; and
adjusting color data according to the sensed illuminant conditions.

22. The method of claim 21, wherein sensing illuminant conditions with an illuminant condition sensor comprises sensing illuminant conditions with a charged coupled device.

23. The method of claim 21, further comprising sensing display emission characteristics and adjusting color data according the sensed display emission characteristics.

24. The method of claim 21, further comprising sensing display reflection characteristics and adjusting color data according the sensed display reflection characteristics.

25. The method of claim 23, wherein sensing display emission characteristics comprises sensing display emission characteristics with the illuminant condition sensor.

26. The method of claim 21, wherein adjusting color data occurs in a color matching module.

27. The method of claim 21, wherein adjusting color data comprises adjusting color data according to an illuminant condition algorithm.

28. The method of claim 21, wherein adjusting color data comprises adjusting color data according to an illuminant condition look-up table.

29. The method of claim 27, wherein adjusting color data further comprises adjusting color data according to an emission characteristics algorithm.

30. The method of claim 28, wherein adjusting color data further comprises adjusting color data according to an emission characteristics look-up table.

31. A system comprising:
a display device including an illuminant condition sensor that senses illuminant conditions surrounding the display device, and
a color matching module coupled to the sensor that adjusts color data according to the sensed illuminant conditions.

32. The system of claim 31, wherein the illuminant condition sensor includes a charged coupled device.

33. The system of claim 31, wherein the illuminant condition sensor further senses emission characteristics of the display device, and
wherein the color matching module further adjusts color data according the sensed emission characteristics.

34. The system of claim 31, wherein the color matching module adjusts color data according to an illuminant condition algorithm.

35. The system of claim 31, wherein the color matching module adjusts color data according to an illuminant condition look-up table.

36. The system of claim 33, wherein the color matching module adjusts color data according to an emission characteristics algorithm.

37. The system of claim 33, wherein the color matching module adjusts color data according to an emission characteristics look-up table.

38. The system of claim 31, further comprising a color management control, the color matching module residing in the color management control.

39. The system of claim 38, further comprising a printing device coupled to the color management control.

40. The system of claim 39, further comprising a plurality of a display devices, each including an illuminant condition sensor that senses illuminant conditions surrounding the respective display device.
